(19) United States
(12) Patent Application Publication
(10) Pub. No.: US 2025/0384701 A1
(43) Pub. Date: Dec. 18, 2025

(54) IMAGE PROCESSING DEVICE, IMAGE PROCESSING METHOD, IMAGE PROCESSING SYSTEM, AND PROGRAM

(71) Applicant: HONDA MOTOR CO., LTD., Minato-ku, Tokyo (JP)

(72) Inventors: Tokitomo Ariyoshi, Wako-shi (JP); Yuji Yasui, Wako-shi (JP)

(21) Appl. No.: 18/878,683

(22) PCT Filed: Jun. 28, 2023
(86) PCT No.: PCT/JP2023/023978

§ 371 Date: Dec. 24, 2024

(30) Foreign Application Priority Data
Jun. 30, 2022 (JP) 2022-106626

(51) Int. Cl. G06V 20/59; G06F 21/62; G06V 40/18

(52) U.S. Cl. CPC G06V 20/597; G06F 21/6254; G06V 40/18

(57) ABSTRACT

Provided is an image processing device including: an image conversion unit that performs an anonymization process on an input image; and an image determination unit that determines whether the input image on which the anonymization process has been performed satisfies a predetermined requirement, wherein the image determination unit performs a predetermined process on the input image on which the anonymization process has been performed in a case where it is determined that the input image on which the anonymization process has been performed satisfies the predetermined requirement, the anonymization process includes a process of changing a face of a person depicted in the input image to a face of another person, and the predetermined requirement is that direction information of the face of the person in the input image matches direction information of the face of the other person in the input image on which the anonymization process has been performed.

### TECHNICAL FIELD

The present invention relates to an image processing device, an image processing method, an image processing system, and a program.

### BACKGROUND ART

In recent years, there has been increased effort to provide access to sustainable transport systems that take into account the vulnerable among transport participants. To achieve this, efforts are focused on research and development aimed at further improving traffic safety and convenience through research and development relating to an automated driving technique. For example, a technique for annotating individual face images to generate learning data used for training a machine learning model is known. Patent Document 1 discloses a technique of generating a synthesized face image by referring to face images of a plurality of persons stored in a face image database, and enables an annotation operation to be performed on the generated synthesized face image.

### CITATION LIST

### Patent Document

Patent Document 1: Japanese Patent No. 5930450

### SUMMARY OF INVENTION

### Technical Problem

The technique disclosed in Patent Document 1 is to protect the privacy of a plurality of persons by having an annotator execute an annotation operation on a synthesized face image synthesized from face images of a plurality of persons. However, in the related art, feature information of the original image may be missing due to the conversion of the original image in order to protect privacy. As a result, there have been cases in which it was not possible to generate learning data which is effective in training a machine learning model while protecting the privacy of a person depicted in the face images.

The present invention was contrived in view of such circumstances, and one object thereof is to provide an image processing device, an image processing method, and a program that make it possible to generate learning data which is effective in training a machine learning model while protecting the privacy of a person depicted in a face image. These will contribute to the development of a sustainable transport system.

### Solution to Problem

The following configurations are adopted in an image processing device, an image processing method, an image processing system, and a program according to this invention.
(1) According to an aspect of this invention, there is provided an image processing device including: an image conversion unit that performs an anonymization process on an input image; and an image determination unit that determines whether the input image on which the anonymization process has been performed satisfies a predetermined requirement, wherein the image determination unit performs a predetermined process on the input image on which the anonymization process has been performed in a case where it is determined that the input image on which the anonymization process has been performed satisfies the predetermined requirement, the anonymization process includes a process of changing a face of a person depicted in the input image to a face of another person, and the predetermined requirement is that direction information of the face of the person in the input image matches direction information of the face of the other person in the input image on which the anonymization process has been performed.
(2) In the aspect of the above (1), the predetermined process is a process of storing the input image on which the anonymization process has been performed as a target image for annotation operation.
(3) In the aspect of the above (1), the predetermined process is a process of storing the input image on which the anonymization process has been performed as learning information for generating a behavior prediction model that predicts a behavior of a person depicted in the input image.
(4) In the aspect of the above (1), the predetermined process is a process of transmitting the input image on which the anonymization process has been performed to an image server through a communication means.
(5) In the aspect of the above (1), the direction information is a gaze direction.
(6) In the aspect of the above (1), the direction information is a face direction.
(7) In the aspect of the above (1), the direction information is a gaze direction of a face and a face direction.
(8) In the aspect of the above (1), when an image is input, the direction information is acquired by inputting the input image to a trained model that has been trained so as to output direction information of a face depicted in the image.
(9) In the aspect of the above (1), in a case where faces of a plurality of persons are present in the input image on which the anonymization process has been performed, the image determination unit determines whether the predetermined requirement is satisfied for a face of a person who is facing forward in a traveling direction of a vehicle equipped with a camera that has captured the input image among the plurality of persons.
(10) In the aspect of the above (1), in a case where faces of a plurality of persons are present in the input image on which the anonymization process has been performed, the image determination unit determines whether the predetermined requirement is satisfied for a face a person whose face depicted in the input image satisfies a predetermined criterion among the plurality of persons.
(11) In the aspect of the above (1), the image conversion unit performs the anonymization process again on the input image in a case where the image determination unit determines that the input image on which the anonymization process has been performed does not satisfy the predetermined requirement.
(12) In the aspect of the above (1), the image conversion unit does not perform the predetermined process on the input image on which the anonymization process has been performed in a case where the image determination unit determines that the input image on which the anonymization process has been performed does not satisfy the predetermined requirement.
(13) According to another aspect of this invention, there is provided an image processing system including: an image conversion unit that performs an anonymization process on an input image: and an image determination unit that determines whether the input image on which the anonymization process has been performed satisfies a predetermined requirement, wherein the image determination unit performs a predetermined process on the input image on which the anonymization process has been performed in a case where it is determined that the input image on which the anonymization process has been performed satisfies the predetermined requirement, the anonymization process includes a process of changing a face of a person depicted in the input image to a face of another person, and the predetermined requirement is that direction information of the face of the person in the input image matches direction information of the face of the other person in the input image on which the anonymization process has been performed.
(14) According to another aspect of this invention, there is provided an image processing method comprising causing a computer to: perform an anonymization process on an input image: determine whether the input image on which the anonymization process has been performed satisfies a predetermined requirement; and perform a predetermined process on the input image on which the anonymization process has been performed in a case where it is determined that the input image on which the anonymization process has been performed satisfies the predetermined requirement, wherein the anonymization process includes a process of changing a face of a person depicted in the input image to a face of another person, and the predetermined requirement is that direction information of the face of the person in the input image matches direction information of the face of the other person in the input image on which the anonymization process has been performed.
(15) According to another aspect of this invention, there is provided a program causing a computer to: perform an anonymization process on an input image: determine whether the input image on which the anonymization process has been performed satisfies a predetermined requirement: and perform a predetermined process on the input image on which the anonymization process has been performed in a case where it is determined that the input image on which the anonymization process has been performed satisfies the predetermined requirement, wherein the anonymization process includes a process of changing a face of a person depicted in the input image to a face of another person, and the predetermined requirement is that direction information of the face of the person in the input image matches direction information of the face of the other person in the input image on which the anonymization process has been performed.

### Advantageous Effects of Invention

According to (1) to (15), it is possible to generate learning data which is effective in training a machine learning model while protecting the privacy of a person depicted in a face image.

### BRIEF DESCRIPTION OF DRAWINGS

FIG. 1 A diagram illustrating an overview of a system 1 including an image processing device 100 according to the present embodiment.

FIG. 2 A diagram illustrating an example of a functional configuration of the image processing device 100 according to the present embodiment.

FIG. 3 A diagram illustrating an example of an in-vehicle image and an out-vehicle image acquired from a vehicle M1.

FIG. 4 A diagram illustrating a process executed by an image processing unit 130.

FIG. 5 A diagram illustrating a process executed by an image conversion unit 140.

FIG. 6 A diagram illustrating an example of time-series in-vehicle images converted by the image conversion unit 140.

FIG. 7 A diagram illustrating a process executed by an image determination unit 150.

FIG. 8 A diagram illustrating an example of an annotation operation executed by an annotator.

FIG. 9 A diagram illustrating an example of driving assistance using a trained model 180.

FIG. 10 A diagram illustrating an example of a flow of processing executed by the image conversion unit 140.

FIG. 11 A diagram illustrating an example of a flow of processing executed by the image determination unit 150.

### DESCRIPTION OF EMBODIMENTS

Hereinafter, an embodiment of an image processing device, an image processing method, an image processing system, and a program of the present invention will be described with reference to the accompanying drawings.

### Overview

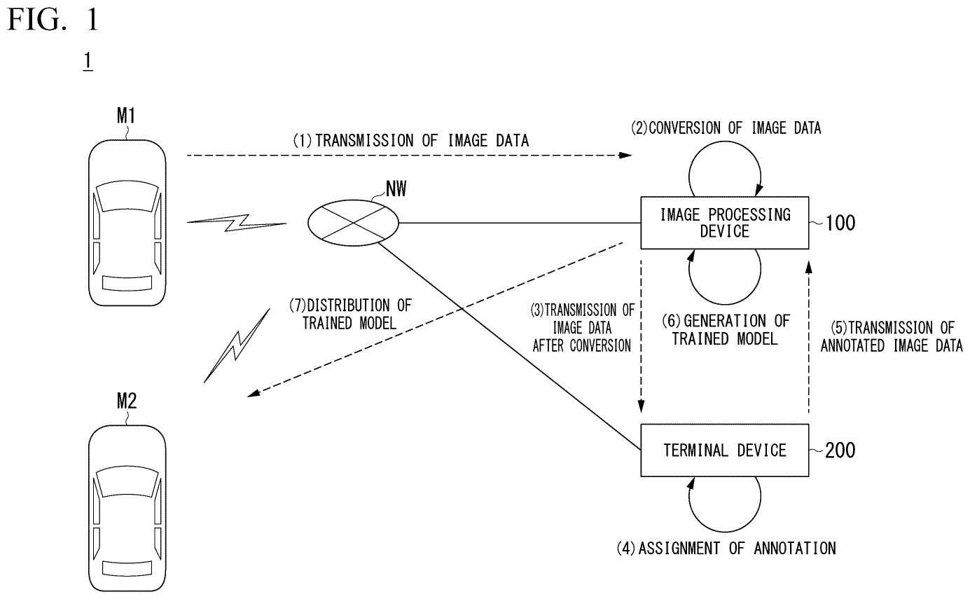

FIG. 1 is a diagram illustrating an overview of a system 1 including an image processing device 100 according to the present embodiment. As shown in FIG. 1, the system 1 includes at least one or more vehicles M1 and M2, the image processing device 100, and a terminal device 200. For convenience of description, the vehicle M1 and the vehicle M2 are illustrated as different vehicles, but these vehicles may be the same.

The vehicle M1 is a four-wheel drive vehicle such as, for example, a hybrid automobile or an electric automobile, and includes at least a camera that captures an image of the interior of the vehicle M1 and a camera that captures an image of outside of the vehicle M1. While traveling, the vehicle M1 transmits the in-vehicle image and out-vehicle image captured by these cameras to the image processing device 100 through a network NW such as a cellular network, a Wi-Fi network, or the Internet.

The image processing device 100 is a server device that, when it receives captured image data including an in-vehicle image and an out-vehicle image from the vehicle M1, performs image conversion, which will be described later, on the received captured image data. This image conversion is a process for protecting the privacy of persons depicted in the in-vehicle image and out-vehicle image. The image processing device 100 transmits the obtained converted image data to the terminal device 200 through the network NW.

The terminal device 200 is a terminal device such as a desktop personal computer or a smartphone. When the converted image data is acquired from the image processing device 100, a user of the terminal device 200 performs an annotation assignment operation, which will be described later, on the acquired converted image data. When the annotation assignment operation is completed, the user of the terminal device 200 transmits the annotated image data, in which the annotations have been assigned to the converted image data, to the image processing device 100.

When the annotated image data is received from the terminal device 200, the image processing device 100 uses the received annotated image data as learning data to generate a trained model to be described later using any machine learning model. This trained model is, for example, a behavior prediction model that, when an out-vehicle image is input, outputs the predicted behavior (trajectory) of a person depicted in the out-vehicle image, or when an in-vehicle image and an out-vehicle image are input, alerts a driver to pedestrians depicted in the out-vehicle image in consideration of the driver's gaze depicted in the in-vehicle image.

Meanwhile, the image data used as learning data in this case may be annotated image data in which the annotations have been assigned to the converted image data, or annotated image data in which the converted image data has been reconverted into captured image data while leaving the annotations intact (that is, annotated image data in which the annotations have been assigned to the captured image data). By using annotated image data, in which the annotations have been assigned to the captured image data, as learning data, it is possible to use learning data which is more realistic and in which the effects of image conversion have been removed.

When the trained model is generated, the image processing device 100 distributes the generated trained model to the vehicle M2 through the network NW. Like the vehicle M1, the vehicle M2 is a four-wheel drive vehicle such as, for example, a hybrid automobile or an electric automobile, and the vehicle M2 obtains behavior prediction data for persons present in the vicinity of the vehicle M2 by inputting at least one of the in-vehicle images and out-vehicle images captured by a camera into the trained model during traveling. The driver of the vehicle M2 can refer to the obtained behavior prediction data and utilize it in driving the vehicle M2. The more detailed content of each process will be described below.

### Functional Configuration of Image Processing Device

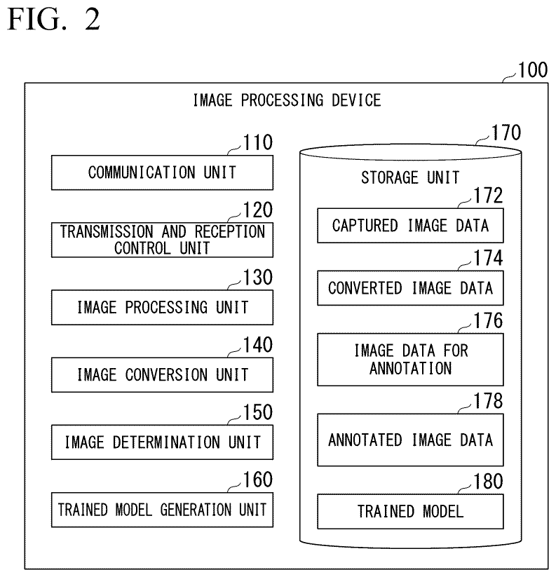

FIG. 2 is a diagram illustrating an example of a functional configuration of the image processing device 100 according to the present embodiment. The image processing device 100 includes, for example, a communication unit 110, a transmission and reception control unit 120, an image processing unit 130, an image conversion unit 140, an image determination unit 150, a trained model generation unit 160, and a storage unit 170. These components are realized, for example, by a hardware processor such as a central processing unit (CPU) executing a program (software). Some or all of these components may be realized by hardware (a circuit unit: including circuitry) such as a large scale integration (LSI), an application specific integrated circuit (ASIC), a field-programmable gate array (FPGA), or a graphics processing unit (GPU), and may be realized by software and hardware in cooperation. The program may be stored in a storage device such as a hard disk drive (HDD) or a flash memory (a storage device including a non-transitory storage medium) in advance, may be stored in a detachable storage medium (non-transitory storage medium) such as a DVD or a CD-ROM, or may be installed by the storage medium being installed in a drive device. The storage unit 170 is, for example, an HDD, a flash memory, a random access memory (RAM), or the like. The storage unit 170 stores, for example, captured image data 172, converted image data 174, image data for annotation 176, annotated image data 178, and a trained model 180. Meanwhile, for convenience of description, the image processing device 100 includes the trained model generation unit 160 and the storage unit 170 that stores the trained model 180, but the function of generating a trained model and the generated trained model may be held by a server device different from the image processing device 100.

The communication unit 110 is an interface that communicates with a communication device 10 of a host vehicle M through the network NW. For example, the communication unit 110 includes a network interface card (NIC), an antenna for wireless communication, and the like.

The transmission and reception control unit 120 uses the communication unit 110 to transmit and receive data between the vehicles M1 and M2 and the terminal device 200. More specifically, the transmission and reception control unit 120 first acquires, from the vehicle M1, a plurality of in-vehicle images and out-vehicle images captured in a time series by a camera mounted in the vehicle M1. The time series in this case involves, for example, images being captured at a predetermined interval (for example, every second) during one traveling cycle from when the vehicle M1 starts to when it stops.

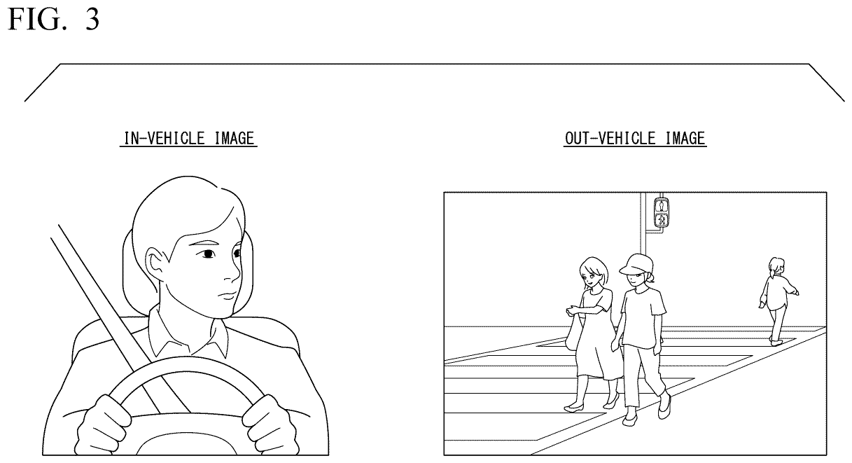

FIG. 3 is a diagram illustrating an example of an in-vehicle image and an out-vehicle image acquired from the vehicle M1. The left part of FIG. 3 represents an in-vehicle image acquired from the vehicle M1, and the right part of FIG. 3 represents an out-vehicle image acquired from the vehicle M1. As shown in the left part of FIG. 3, the in-vehicle image is captured with a camera installed so as to capture an image of at least the face area of the driver of the vehicle M1, and as shown in the right part of FIG. 3, the out-vehicle image is captured with a camera installed so as to capture at least a forward image of the vehicle M1 in its traveling direction. The transmission and reception control unit 120 associates the in-vehicle image and out-vehicle image acquired from the vehicle M1 with an image ID and stores these images in the storage unit 170 as the captured image data 172.

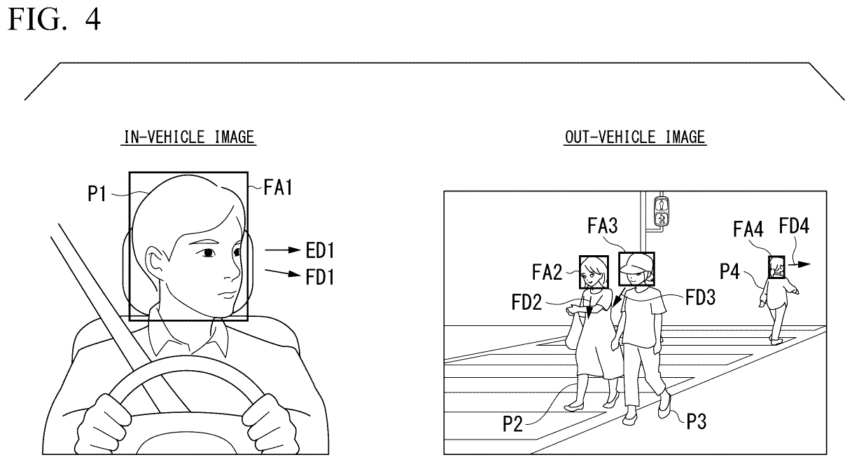

FIG. 4 is a diagram illustrating a process executed by the image processing unit 130. The image processing unit 130 performs image processing on the captured image data 172 and acquires information such as image attributes, face attributes, and direction of each image included in the captured image data 172. More specifically, when an image is input, the image processing unit 130 uses a trained model that outputs a classification result indicating whether the image is an in-vehicle image or an out-vehicle image to acquire image attributes indicating whether each image included in the captured image data 172 is an in-vehicle image or an out-vehicle image.

Further, when an image is input, the image processing unit 130 acquires the face attributes of each image included in the captured image data 172 using a trained model that outputs, for all faces included in the image, the face area, the size of the face (the size of the face area), and the distance from the shooting position of the image to the face. In FIG. 3, as an example, a face area FA1 of a person P1 is acquired from the in-vehicle image, and a face area FA2 of a person P2, a face area FA3 of a person P3, and a face area FA4 of a person P4 are acquired from the out-vehicle image. For convenience, the face areas FA1, FA2, FA3, and FA4 are acquired as rectangular areas, but the present invention is not limited to such a configuration, and, for example, a trained model that acquires a face area along the contour of a person's face may be used.

Further, when an image is input, the image processing unit 130 acquires direction information for the faces depicted in each image included in the captured image data 172 using a trained model that outputs at least one of the face direction and gaze direction for all faces included in the image, for example, as a vector. More specifically, for an image of the captured image data 172 having attributes of an in-vehicle image, the image processing unit 130 acquires direction information using a trained model that, when the image is input, outputs the face direction and gaze direction for all faces included in the image. On the other hand, for an image of the captured image data 172 having attributes of an out-vehicle image, the image processing unit 130 acquires direction information using a trained model that, when the image is input, outputs the face direction for all faces included in the image. This is because, in general, the faces depicted in the in-vehicle image are closer to the shooting position than those in the out-vehicle image, and are more likely to be captured large enough that the gaze direction can be extracted. In FIG. 3, as an example, the face direction FD1 and gaze direction ED1 of the person P1 are acquired from the in-vehicle image, and the face direction FD2 of the person P2, the face direction FD3 of the person P3, and the face direction FD4 of the person P4 are acquired from the out-vehicle image.

When the image attributes, face attributes, and direction information are acquired for each image of the captured image data 172, the image processing unit 130 records these image attributes, face attributes, and direction information in association with the image. Meanwhile, in the above, as an example, the image processing unit 130 acquires the image attributes, face attributes, and direction information using a trained model, but the present invention is not limited to such a configuration, and the image processing unit 130 may acquire these image attributes, face attributes, and direction information using any known method.

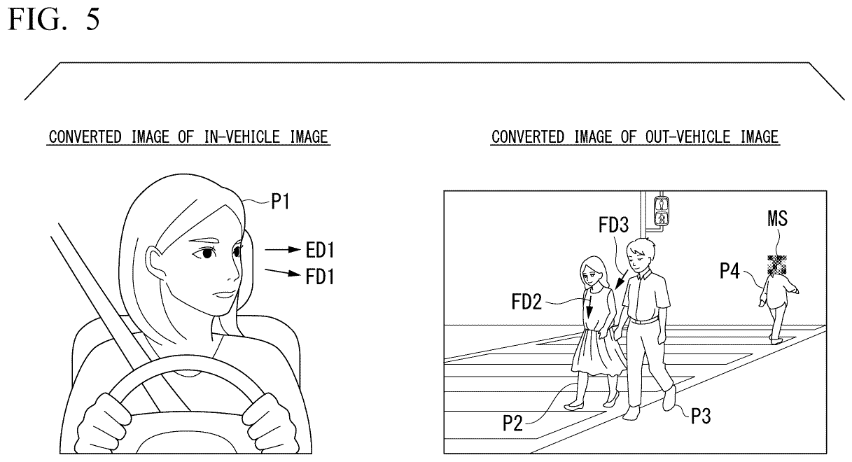

The image conversion unit 140 executes, on the captured image data 172 processed by the image processing unit 130, a process of replacing the face of a person depicted in each image with the face of another person without changing the direction information of the person, using any software in which such a function is implemented. FIG. 5 is a diagram illustrating a process executed by the image conversion unit 140. As shown in FIG. 5, the image conversion unit 140 replaces the faces of the persons P1, P2, and P3 shown in FIG. 4 with the faces of other persons without changing the gaze direction ED1 and the face directions FD1, FD2, and FD3. On the other hand, the face of the person P4 is covered with a mosaic MS as a result of mosaic processing performed by the image conversion unit 140.

That is, on the basis of the face attributes of each face depicted in each image of the captured image data 172, the image conversion unit 140 determines whether to replace the face with the face of another person or to perform mosaic processing. More specifically, the image conversion unit 140 determines, for each face depicted in each image the captured image data 172, whether the size of the face is equal to or greater than a first threshold Th1, and determines to replace the face with the face of another person in a case where it is determined that the size of the face is equal to or greater than the first threshold Th1. On the other hand, in a case where it is determined that the size of the face is less than the first threshold Th1, the image conversion unit 140 determines to perform mosaic processing on the face. Replacing the face of a person depicted in a captured image with the face of another person or performing mosaic processing is an example of an “anonymization process.”

In addition, the image conversion unit 140 determines, for each face depicted in each image of the captured image data 172, whether the distance of the face is equal to or less than a second threshold Th2, and determines to replace the face with the face of another person in a case where it is determined that the distance of the face is equal to or less than the second threshold Th2. On the other hand, in a case where it is determined that the distance of the face is greater than the second threshold Th2, the image conversion unit 140 determines to perform mosaic processing on the face. The image conversion unit 140 repeatedly executes these determination processes as many times as the number of faces depicted in the image, and replaces each face with the face of another person or performs mosaic processing in accordance with the determination results. The image conversion unit 140 stores image data obtained by performing such processing on the captured image data 172, as the converted image data 174, in the storage unit 170. This makes it possible to select data which is useful as learning data for generating a behavior prediction model, and to protect the privacy of a person depicted in each image when an annotator who will be described later performs an annotation operation.

Meanwhile, at least one of the process of determining whether the size of a face is equal to or greater than the first threshold Th1 and the process of determining whether the distance of the face is equal to or less than the second threshold Th2 need only be performed. When both processes are performed, the image conversion unit 140 may determine to replace the face with the face of another person in a case where the size of the face is equal to or greater than the first threshold Th1 and the distance of the face is equal to or less than the second threshold Th2, or may determine to replace the face with the face of another person in a case where the size of face is equal to or greater than the first threshold Th1 or the distance of the face is equal to or less than the second threshold Th2.

Further, the image conversion unit 140 may selects faces to be utilized as learning data by performing mosaic processing on faces for which direction information has failed to be acquired among faces depicted in each image of the captured image data 172.

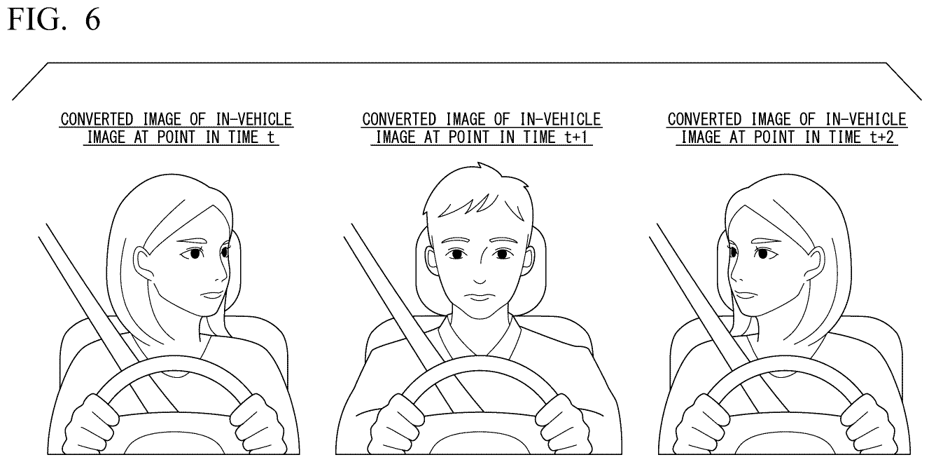

FIG. 6 is a diagram illustrating an example of time-series in-vehicle images converted by the image conversion unit 140. As an example, FIG. 6 shows an example in which time-series in-vehicle images at three points in time, t, t+1, and t+2, are converted. These time-series in-vehicle images are those obtained by performing image capture and face conversion on an image of the same person, but as shown in FIG. 6, depending on the operation of face conversion software, the face of the same person may be converted into the faces of a plurality of different persons. In spite of the face of the same person being converted into the faces of a plurality of different persons, using such converted image data as it is as learning data is not desirable because it can cause the accuracy of the behavior prediction model to deteriorate. Therefore, the image determination unit 150 determines the continuity of the time-series in-vehicle images and out-vehicle images by executing the process which will be described below.

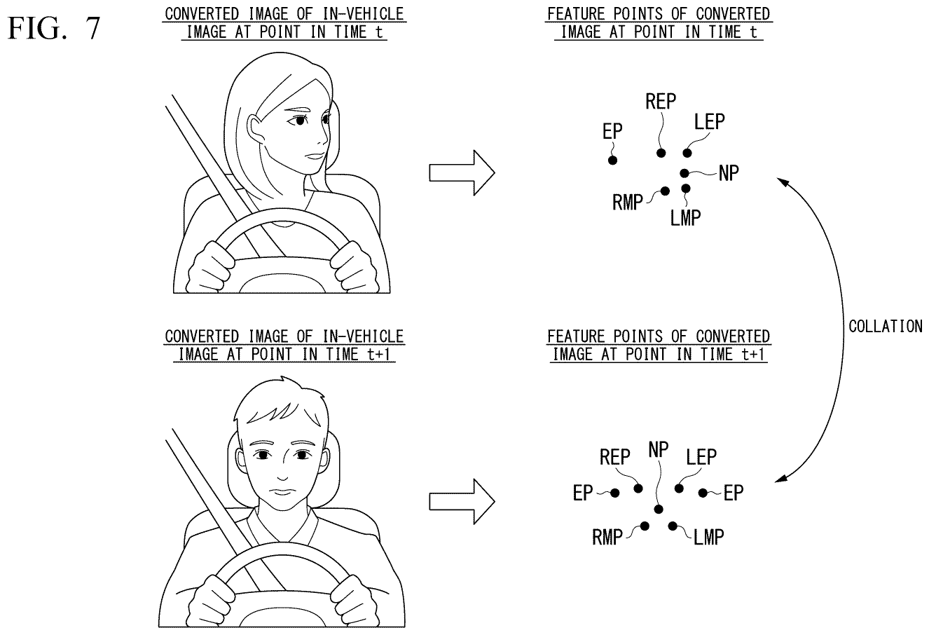

FIG. 7 is a diagram illustrating a process executed by the image determination unit 150. As shown in FIG. 7, the image determination unit 150 first extracts feature points representing a face from the face of a person depicted in the converted image. For example, the image determination unit 150 extracts feature points representing the right eye REP, the left eye LEP, the nose NP, the right corner of the mouth RMP, the left corner of the mouth LMP, and the ears EP of a face from the face of a person depicted in the converted image. The image determination unit 150 extracts the feature points of the faces of persons tracked as the same person from each of the time-series converted images, and collates these feature points. Meanwhile, as to whether the persons have been “tracked as the same person,” the same person depicted in the captured image need only be associated, for example, at a stage before the image is converted.

In the case of FIG. 7, the image determination unit 150 extracts the feature points of a person depicted in in the converted image at the point in time t and the feature points of a person depicted in the converted image at the point in time t+1. The image determination unit 150 performs collation by determining whether these two sets of extracted feature points substantially match through translation and rotation.

In a case where the extracted feature points are determined to substantially match as a result of collation, the image determination unit 150 determines that the faces of the persons tracked as the same person are still the face of the same person after conversion (that is, there is continuity in the face). On the other hand, in a case where the extracted feature points are determined not to substantially match as a result of collation, the image determination unit 150 determines that the faces of the persons tracked as the same person are not the face of the same person after conversion (that is, there is no continuity in the face). In that case, the image conversion unit 140 performs a conversion process again on the face determined to have no continuity. At this time, the image conversion unit 140 may perform the conversion process again only on the face determined to have no continuity, or may perform the conversion process again on the faces of all persons depicted in the time-series converted images. In addition, for example, the image conversion unit 140 may perform mosaic processing on the face determined to have no continuity without performing the conversion process again, and exclude the face from being utilized as learning data. In addition, for example, in a case where the image determination unit 150 determines that the faces of the persons tracked as the same person are not the face of the same person after conversion (that is, there is no continuity in the face), the image determination unit 150 may restrict the application of a predetermined process to the time-series converted images, that is, exclude the time-series converted images from being utilized as learning data. This makes it possible to prevent discontinuity caused by unintended operations of the face conversion software from occurring.

The image determination unit 150 further inputs the converted image again into the above trained model that outputs at least one of the face direction and the gaze direction, and acquires the face direction FD or the gaze direction ED in the converted image. The image determination unit 150 determines whether the face direction FD or the gaze direction ED of the face of the person depicted in the converted image substantially matches the face direction FD or the gaze direction ED of the face depicted in the captured image before conversion. As described above, both the face direction FD and the gaze direction ED are acquired for the in-vehicle image, and the face direction FD is acquired for the out-vehicle image. Therefore, the image determination unit 150 determines whether the face direction FD and the gaze direction ED substantially match between the captured image before conversion and the converted image for the in-vehicle image, and determines whether the face direction FD substantially matches between the captured image before conversion and the converted image for the out-vehicle image. More specifically, for example, the image determination unit 150 calculates the angle difference between a vector representing the face direction FD in the captured image before conversion and a vector representing the face direction FD in the converted image, and determines that the face direction FD substantially matches in a case where the calculated angle difference is within a threshold. The same applies to the gaze direction ED. The continuity of the face or the consistency of the direction information being satisfied is an example of a “predetermined requirement.”

In a case where it is determined that face direction FD or the gaze direction ED not substantially match between the captured image before conversion and the converted image, the image conversion unit 140 performs the conversion process again on the captured image for the face whose face direction FD or gaze direction ED is determined not to substantially match. At this time, the image conversion unit 140 may perform the conversion process again only on the faces determined not to substantially match, or may perform the conversion process again on all faces included in the converted image, including the faces determined not to substantially match. In addition, for example, the image conversion unit 140 may perform mosaic processing on the faces determined not to substantially match without performing the conversion process again, and exclude the face from being utilized as learning data. In addition, for example, in a case where the image determination unit 150 determines that the faces do not substantially match, the image determination unit 150 may restrict the application of a predetermined process to the time-series converted images, that is, exclude the time-series converted images from being utilized as learning data. This makes it possible to prevent deterioration of information caused by unintended operations of the face conversion software.

Meanwhile, in a case where there are a plurality of faces depicted in the converted image (or a case where the number of faces depicted in the converted image is equal to or greater than a predetermined value), the determination process relating to the continuity of the converted image and the determination process relating to the consistency of the direction information which are executed by the image determination unit 150 described above may be executed only on a face which is assumed to be of higher importance rather than on all faces depicted in the converted image. As an example of a face which is assumed to be of higher importance, the image determination unit 150 may execute these determination processes only for a face whose face size is equal to or greater than a third threshold Th3 which is greater than the first threshold Th1 in the captured image before conversion, or may execute these determination processes only for a face whose face distance is equal to or less than a fourth threshold Th4 which is smaller than the second threshold Th2. In addition, for example, the image determination unit 150 may assume that the face of a person present in front of the vehicle M1 in its traveling direction, or the face of a person whose face direction is toward the front of the vehicle M1 in its traveling direction, in the captured image before conversion, is of higher importance, and execute these determination processes. In addition, for example, in a case where the continuity or consistency is denied for a certain face depicted in the converted image, a reconversion process may be executed for the face and a face which is assumed to be of high importance.

When the continuity and consistency are confirmed for the time-series converted images, the image determination unit 150 stores the converted image data 174 for which the continuity and consistency are confirmed in the storage unit 170 as the image data for annotation 176. In this case, the converted image data 174 may be stored in the storage unit 170 as the image data for annotation 176 together with information indicating the purpose of use, for example, information indicating that the converted image data 174 is image data for annotation for generating a behavior prediction model that predicts the behavior of a person depicted in the input image. The transmission and reception control unit 120 transmits the image data for annotation 176 to the terminal device 200. The annotator who is a user of the terminal device 200 generates annotated image data by performing an annotation operation on the image for annotation included in the received image data for annotation 176, and transmits the annotated image data to the image processing device 100. The image processing device 100 stores the received annotated image data in the storage unit 170 as the annotated image data 178.

Meanwhile, at least one of the determination process relating to the continuity of the converted image and the determination process relating to the consistency of the face direction information which are executed by the image determination unit 150 described above need only be executed, and in a case where at least one of the continuity and the consistency is established, the converted image data 174 may be stored in the storage unit 170 as the image data for annotation 176.

Further, in a case where there are, for example, missing images in a time series of captured images (or, their converted images) obtained at a predetermined interval (for example, every second) during one traveling cycle due to malfunction of a camera or the like, the image determination unit 150 does not need to store all of these time-series images in the storage unit 170 as the image data for annotation 176.

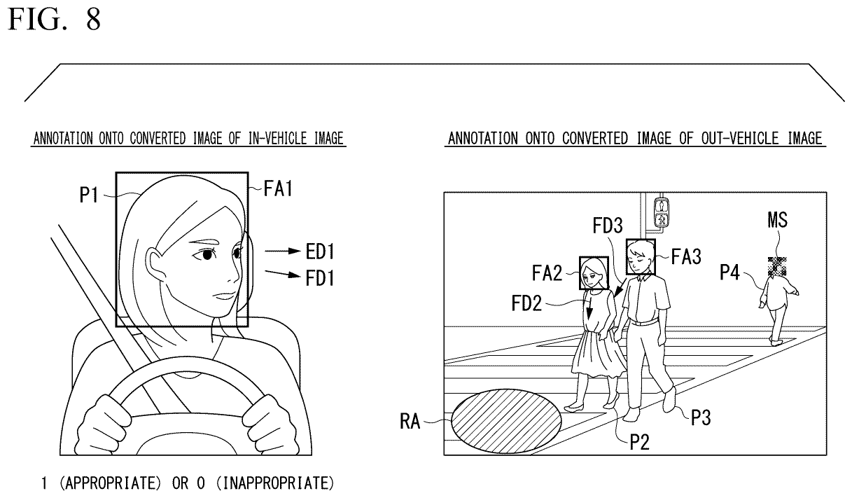

FIG. 8 is a diagram illustrating an example of an annotation operation executed by an annotator. The left part of FIG. 8 shows annotations onto the converted image of the in-vehicle image, and the right part of FIG. 8 shows annotations onto the converted image of the out-vehicle image. The annotator assigns, to the converted image of the in-vehicle image, information indicating, for example, whether the gaze direction ED1 of the driver depicted in the converted image is appropriate in a situation shown in the converted image of the out-vehicle image at the same point in time (for example, 1 if appropriate, and 0 if inappropriate). For example, in the case of FIG. 8, the converted image of the out-vehicle image shows that there are pedestrians on the left side in the traveling direction of the vehicle, while the converted image of the in-vehicle image shows that the driver's gaze is toward the left direction. In other words, since it is assumed that the driver is paying appropriate attention to the pedestrians, the annotator assigns information indicating that the gaze direction ED1 of the driver is appropriate (that is, 1).

Further, for the converted image of the out-vehicle image, the annotator specifies a risk area RA into which persons depicted in the converted image, for example, excluding persons who have undergone mosaic processing, are predicted to proceed. Since the face of a person depicted in the original image has been converted into the face of another person through the processing performed by the image conversion unit 140 and the image determination unit 150, the privacy of the person is protected. At the same time, since the face direction and gaze direction of a person are maintained even after conversion, the annotator can accurately specify the risk area RA while referring to the face direction and gaze direction of another person depicted in the converted image. This makes it possible to generate learning data which is effective in training a machine learning model while protecting the privacy of a person depicted in the face image.

Once the annotated image data 178 is stored in the storage unit 170, the trained model generation unit 160 generates a trained model using any machine learning model with the annotated image data 178 as learning data. As described above, this trained model is, for example, a behavior prediction model that, when an out-vehicle image is input, outputs the predicted behavior (trajectory) of a person depicted in the out-vehicle image, or when an in-vehicle image and an out-vehicle image are input, alerts the driver to pedestrians depicted in the out-vehicle image in consideration of the driver's gaze depicted in the in-vehicle image. The trained model generation unit 160 stores the generated trained model in the storage unit 170 as the trained model 180.

Once the trained model 180 is generated, the transmission and reception control unit 120 distributes the generated trained model 180 to the vehicle M2 through the network NW. When the trained model 180 is received, the vehicle M2 uses the trained model 180 (more precisely, an application program in which the trained model 180 is utilized) to provide driving assistance to the driver of the vehicle M2.

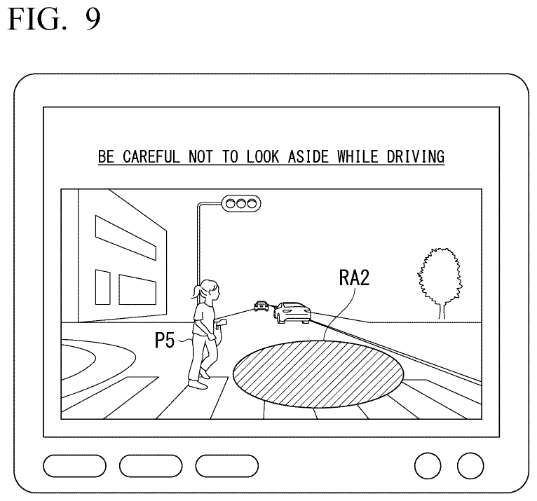

FIG. 9 is a diagram illustrating an example of driving assistance using the trained model 180. FIG. 9 shows an example of driving assistance in which the vehicle M2 inputs an in-vehicle image and an out-vehicle image captured by an onboard camera during its traveling to the trained model 180, and the trained model 180 outputs information for alerting the driver to pedestrians depicted in the out-vehicle image to a human machine interface (HMI) in consideration of the driver's gaze depicted in the in-vehicle image. As shown in FIG. 9, for example, the HMI displays a risk area RA2 corresponding to a pedestrian P5 depicted in the out-vehicle image, and outputs a warning message (“Be careful not to look aside while driving”) as text information or voice information in a case where the driver's gaze depicted in the in-vehicle image is not directed toward the pedestrian P5. This makes it possible to realize driving assistance considering the driver's condition.

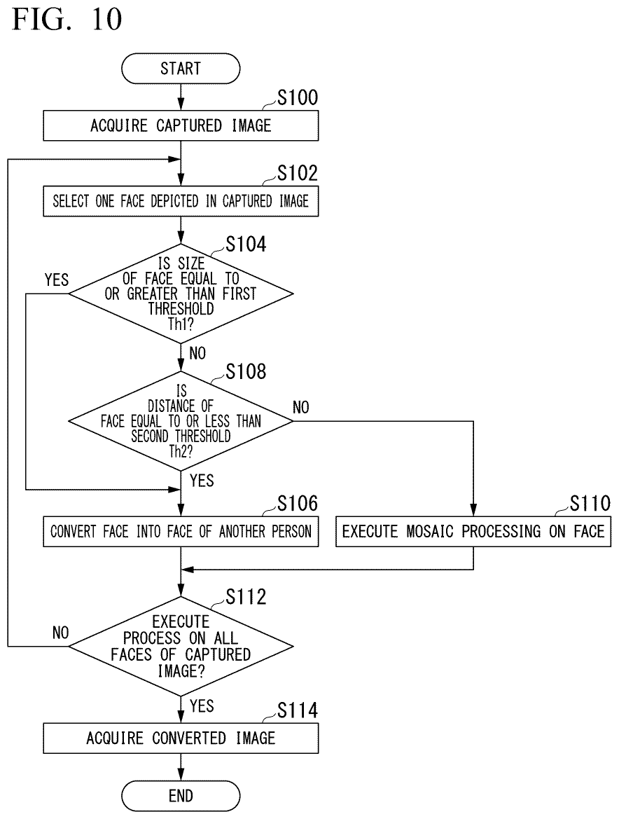

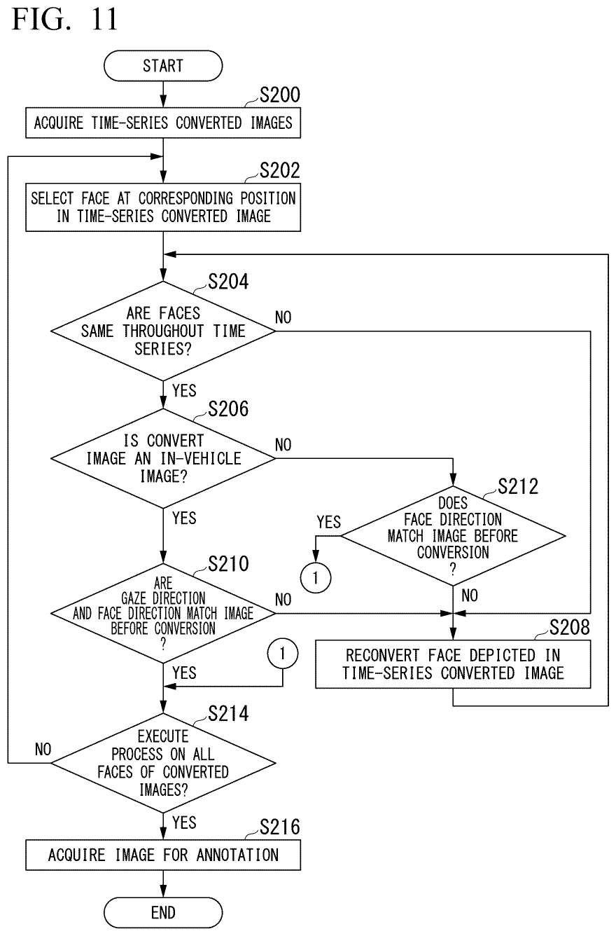

Next, the flow of processing executed by the image processing device 100 will be described with reference to FIGS. 10 and 11. FIG. 10 is a diagram illustrating an example of a flow of processing executed by the image conversion unit 140. The processing shown in FIG. 10 is executed, for example, at a timing when an in-vehicle image or an out-vehicle image is captured by a camera mounted on the vehicle M1 and are processed by the image processing unit 130.

First, the image conversion unit 140 acquires a captured image included in the captured image data 172 that has been processed by the image processing unit 130 (step S100). Next, the image conversion unit 140 selects one of the faces depicted in the acquired captured image (step S102).

Next, the image conversion unit 140 determines whether the size of the selected face is equal to or greater than the first threshold Th1 (step S104). In a case where it is determined that the size of the selected face is equal to or greater than the first threshold Th1, the image conversion unit 140 converts the selected face into the face of another person (step S106). On the other hand, in a case where it is determined that the size of the selected face is less than the first threshold Th1, the image conversion unit 140 next determines whether the distance of the selected face is equal to or less than the second threshold Th2 (step S108).

In a case where it is determined that the distance of the selected face is equal to or less than the second threshold Th2, the image conversion unit 140 proceeds to step S106 and converts the selected face into the face of another person. On the other hand, in a case where it is determined that the distance of the selected face is greater than the second threshold Th2, the image conversion unit 140 performs mosaic processing on the face (step S110). Next, the image conversion unit 140 determines whether the process has been executed on all the faces depicted in the acquired captured image (step S112).

In a case where it is determined that the process has been executed on all the faces depicted in the acquired captured image, the image conversion unit 140 acquires the image obtained by executing the process on all the faces as a converted image, and stores it in the storage unit 170 as the converted image data 174 (step S114). On the other hand, in a case where it is determined that the process has not been executed on all the faces depicted in the acquired captured image, the image conversion unit 140 returns the process to step S102. This completes the processing of this flowchart. FIG. 11 is a diagram illustrating an example of a flow of processing executed by the image determination unit 150. The processing shown in FIG. 11 is executed, for example, at the timing when time-series converted images are obtained by performing the above conversion process on the time-series captured images captured during one traveling cycle from the start to the stop of the vehicle M1.

First, the image determination unit 150 acquires time-series converted images (step S200). Next, the image determination unit 150 selects the faces of persons tracked as the same person before conversion in the acquired time-series converted images (step S202).

Next, the image determination unit 150 extracts feature points from the faces of persons tracked as the same person before conversion from each of the time-series converted images, and performs collation to determine whether these faces are the same as each other even after conversion (step S204). In a case where it is determined that the faces are the same as each other even after conversion, the image determination unit 150 next determines whether the acquired time-series converted images are in-vehicle images (step S206). On the other hand, in a case where it is determined that the faces are not the same as each other, the image determination unit 150 causes the image conversion unit 140 to convert the faces of persons tracked as the same person before conversion in the time-series captured images again (step S208). Thereafter, the image determination unit 150 executes the processes of step S204 again on the converted faces.

In a case where it is determined in step S206 that the acquired time-series converted images are in-vehicle images, the image determination unit 150 determines whether the gaze direction and face direction of these faces match those of the images before conversion (step S210). On the other hand, in a case where it is determined that the acquired time-series converted images are not in-vehicle images, that is, are out-vehicle images, the image determination unit 150 determines whether the face direction of these faces matches that of the images before conversion (step S212). In a case where it is determined in the processes of step S210 or step S212 that there is no match, the image determination unit 150 advances the process to step S208.

In a case where a match is determined in the process of step S210 or step S212, the image determination unit 150 determines that these faces have been converted normally, and determines whether the process has been executed on all the faces depicted in the time-series converted images (step S214). In a case where it is determined that the process has been executed on all the faces depicted in the time-series converted images, the image determination unit 150 acquires these time-series converted images as images for annotation, and causes the transmission and reception control unit 120 to transmit the acquired images for annotation to the terminal device 200 (step S216). On the other hand, in a case where it is determined that the process has not been executed on all the faces depicted in the time-series converted images, the image determination unit 150 returns the process to step S202. This completes the processing of this flowchart.

According to the present embodiment described above, in a case where it is determined that a plurality of input images on which an anonymization process has been performed satisfy a predetermined requirement, a predetermined process is performed on the plurality of input images on which the anonymization process has been performed, the anonymization process includes a process of changing the face of a person depicted in a plurality of input images into the face of another person, and the predetermined requirement includes that the faces of the persons tracked as the same person in the plurality of input images and depicted in the plurality of input images on which the anonymization process has been performed are the face of the same person even after the anonymization process. That is, in the present embodiment, faces belonging to the same person before the anonymization process are guaranteed to be the faces of the same person even in the anonymization process, and are utilized as learning data. This makes it possible to generate learning data which is effective in training a machine learning model while protecting the privacy of a person depicted in the face image.

In addition, according to the present embodiment, the predetermined requirement includes that the direction information of the faces of the persons tracked as the same person in a plurality of input images matches the direction information of the face of the same person in the plurality of input images on which the anonymization process has been performed. That is, in the present embodiment, it is guaranteed that the direction information of the face of the same person remains unchanged even after the anonymization process is performed. This makes it possible to generate learning data which is effective in training a machine learning model while protecting the privacy of a person depicted in the face image.

In addition, according to the present embodiment, the predetermined requirement is determined in accordance with the image attributes which are image capture aspects of a plurality of input images. That is, in the present embodiment, a predetermined process which is, for example, a process of performing storage as learning information for generating a behavior prediction model is executed in consideration of the each of the image capture aspects of each of the plurality of input images. This makes it possible to generate learning data which is effective in training a machine learning model while protecting the privacy of a person depicted in the face image.

In addition, according to the present embodiment, a determination is made as to whether to perform the anonymization process using a first method or to perform the anonymization process using a second method different from the first method on the basis of the size of the face depicted in each of the plurality of input images or the distance from the image capture point to the face. That is, in the present embodiment, the method of the anonymization process performed on a face is changed depending on whether it is useful for training a machine learning model. This makes it possible to generate learning data which is effective in training a machine learning model while protecting the privacy of a person depicted in the face image.

### MODIFICATION EXAMPLE

As described above, in the present embodiment, an example has been described in which, in a case where the image determination unit 150 determines that a face depicted in a converted image does not satisfy a predetermined requirement, the converted image is reconverted or subjected to mosaic processing. However, in a case where the image determination unit 150 determines that the predetermined requirement is not satisfied, the image determination unit 150 may perform a process such as not performing the predetermined process on the converted image, that is, restricting performing the predetermined process (not storing the image, not transmitting it to a server, or the like).

Further, in the present embodiment, an example has been described in which the image processing device 100 is implemented as a server device which is separate from the vehicle M1. However, as a modification example of the present embodiment, the image processing device 100, more specifically, a device having at least the functions of the image processing unit 130, the image conversion unit 140, and the image determination unit 150, may be mounted in the vehicle M1 as an in-vehicle device. In that case, the in-vehicle device performs processing on the image captured by the in-vehicle camera using the image processing unit 130 described above, performs anonymization using the image conversion unit 140, and performs determination using the image determination unit 150. Thereafter, the in-vehicle device transmits the anonymized image for which the continuity of the face and the consistency of the direction information have confirmed by the image determination unit 150 to an external image server.

When an anonymized image is received from the vehicle M1, the image server accumulates the received anonymized image in a storage unit as image data for annotation, and either transmits the image data for annotation to the terminal device 200 of the annotator or allows the terminal device 200 to access the image data for annotation. When annotated image data is received from the terminal device 200, the image server generates the trained model 180 on the basis of the annotated image data and distributes the generated trained model 180 to the vehicle M2. In this way, as in the present embodiment, it is possible to generate learning data which is effective in training a machine learning model while protecting the privacy of a person depicted in the face image. Further, according to this modification example, the in-vehicle device performs the anonymization process on the image and then transmits the anonymized image to the image server, so that the privacy of a person depicted in the face image can be protect more reliably.

Further, as another aspect, the in-vehicle device may have only some of the functions of the image processing unit 130, the image conversion unit 140, and the image determination unit 150, and the image server may have the remaining functions. For example, the in-vehicle device may have the functions of the image processing unit 130 and the image conversion unit 140, the image server may have the functions of the image determination unit 150, the in-vehicle device may have the functions of the image processing unit 130, and the image server may have the functions of the image conversion unit 140 and the image determination unit 150.

The above-described embodiment can be represented as follows.

An image processing device including:
a storage medium having computer-readable instructions stored therein; and
a processor connected to the storage medium,
wherein the processor executes the computer-readable instructions to
perform an anonymization process on an input image,
determine whether the input image on which the anonymization process has been performed satisfies a predetermined requirement, and
perform a predetermined process on the input image on which the anonymization process has been performed in a case where it is determined that the input image on which the anonymization process has been performed satisfies the predetermined requirement,
the anonymization process includes a process of changing a face of a person depicted in the input image to a face of another person, and
the predetermined requirement is that direction information of the face of the person in the input image matches direction information of the face of the other person in the input image on which the anonymization process has been performed.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### REFERENCE SIGNS LIST

100 Image processing device
110 Communication unit
120 Transmission and reception control unit
130 Image processing unit
140 Image conversion unit
150 Image determination unit
160 Trained model generation unit
170 Storage unit
172 Captured image data
174 Converted image data
176 Image data for annotation
178 Annotated image data
180 Trained model

What is claim is:

1. An image processing device comprising:
an image conversion unit that performs an anonymization process on an input image; and
an image determination unit that determines whether the input image on which the anonymization process has been performed satisfies a predetermined requirement,
wherein the image determination unit performs a predetermined process on the input image on which the anonymization process has been performed in a case where it is determined that the input image on which the anonymization process has been performed satisfies the predetermined requirement,
the anonymization process includes a process of changing a face of a person depicted in the input image to a face of another person, and
the predetermined requirement is that direction information of the face of the person in the input image matches direction information of the face of the other person in the input image on which the anonymization process has been performed.

2. The image processing device according to claim 1, wherein the predetermined process is a process of storing the input image on which the anonymization process has been performed as a target image for annotation operation.

3. The image processing device according to claim 1, wherein the predetermined process is a process of storing the input image on which the anonymization process has been performed as learning information for generating a behavior prediction model that predicts a behavior of a person depicted in the input image.

4. The image processing device according to claim 1, wherein the predetermined process is a process of transmitting the input image on which the anonymization process has been performed to an image server through a communication means.

5. The image processing device according to claim 1, wherein the direction information is a gaze direction.

6. The image processing device according to claim 1, wherein the direction information is a face direction.

7. The image processing device according to claim 1, wherein the direction information is a gaze direction of a face and a face direction.

8. The image processing device according to claim 1, wherein, when an image is input, the direction information is acquired by inputting the input image to a trained model that has been trained so as to output direction information of a face depicted in the image.

9. The image processing device according to claim 1, wherein, in a case where faces of a plurality of persons are present in the input image on which the anonymization process has been performed, the image determination unit determines whether the predetermined requirement is satisfied for a face of a person who is facing forward in a traveling direction of a vehicle equipped with a camera that has captured the input image among the plurality of persons.

10. The image processing device according to claim 1, wherein, in a case where faces of a plurality of persons are present in the input image on which the anonymization process has been performed, the image determination unit determines whether the predetermined requirement is satisfied for a face a person whose face depicted in the input image satisfies a predetermined criterion among the plurality of persons.

11. The image processing device according to claim 1, wherein the image conversion unit performs the anonymization process again on the input image in a case where the image determination unit determines that the input image on which the anonymization process has been performed does not satisfy the predetermined requirement.

12. The image processing device according to claim 1, wherein the image conversion unit does not perform the predetermined process on the input image on which the anonymization process has been performed in a case where the image determination unit determines that the input image on which the anonymization process has been performed does not satisfy the predetermined requirement.

13. An image processing system comprising:
an image conversion unit that performs an anonymization process on an input image; and
an image determination unit that determines whether the input image on which the anonymization process has been performed satisfies a predetermined requirement,
wherein the image determination unit performs a predetermined process on the input image on which the anonymization process has been performed in a case where it is determined that the input image on which the anonymization process has been performed satisfies the predetermined requirement,
the anonymization process includes a process of changing a face of a person depicted in the input image to a face of another person, and
the predetermined requirement is that direction information of the face of the person in the input image matches direction information of the face of the other person in the input image on which the anonymization process has been performed.

14. An image processing method comprising causing a computer to:
perform an anonymization process on an input image;
determine whether the input image on which the anonymization process has been performed satisfies a predetermined requirement; and
perform a predetermined process on the input image on which the anonymization process has been performed in a case where it is determined that the input image on which the anonymization process has been performed satisfies the predetermined requirement,
wherein the anonymization process includes a process of changing a face of a person depicted in the input image to a face of another person, and
the predetermined requirement is that direction information of the face of the person in the input image matches direction information of the face of the other person in the input image on which the anonymization process has been performed.

15. A non-transitory computer-readable storage medium having stored thereon a program causing a computer to:
perform an anonymization process on an input image;
determine whether the input image on which the anonymization process has been performed satisfies a predetermined requirement; and
perform a predetermined process on the input image on which the anonymization process has been performed in a case where it is determined that the input image on which the anonymization process has been performed satisfies the predetermined requirement,
wherein the anonymization process includes a process of changing a face of a person depicted in the input image to a face of another person, and
the predetermined requirement is that direction information of the face of the person in the input image matches direction information of the face of the other person in the input image on which the anonymization process has been performed.
